(19) United States
(12) Patent Application Publication
(10) Pub. No.: US 2025/0063051 A1
(43) Pub. Date: Feb. 20, 2025

(54) SYSTEM AND METHOD FOR PERSONALIZED APPLICATION MANAGEMENT

(71) Applicant: PLUME DESIGN, INC., Palo Alto, CA (US)

(72) Inventor: Robert MILLER, Menlo Park, CA (US)

(21) Appl. No.: 18/450,666

(22) Filed: Aug. 16, 2023

(51) Int. Cl. H04L 9/40; H04L 67/50

(52) U.S. Cl. CPC H04L 63/107; H04L 67/535

(57) ABSTRACT

Disclosed are systems and methods that provide a novel framework for personalized application control management for a user. The framework can provide dynamically determined, customized application management mechanisms that provide non-native functionality to applications and/or the devices executing thereon to enable, thwart and/or manipulate how applications can be accessed, which features are accessible and/or whether such applications and/or features are accessible via connected network functionality. The comprehensive application optimization framework provides a robust management and control tool that can impart functional operations to manage how devices and/or networks operate respective to applications' access requests, which can be dependent on learned activities corresponding to specific times and/or locations.

### FIELD OF THE DISCLOSURE

The present disclosure is generally related to an application monitoring and control system, and more particularly, to a decision intelligence (DI)-based computerized framework for automatically and dynamically managing real-time application usage on connected devices.

### BACKGROUND

Currently, restrictions, limits or other guidelines for managing whether applications are appropriate are entirely user preference/settings based. That is, for example, parental control or “screen time limits” can be set by a user, which can govern how other users can access applications on a device.

### SUMMARY OF THE DISCLOSURE

Moreover, there is currently no mechanism that can correlate the context in which an application is being requested to determine whether it is appropriate. For example, is a social media application appropriate when a user is at work (e.g., time and place/location). The answer, however, is not straight forward, as the context of the user's employment may mean that social media applications are in fact appropriate if the user's job aligns with such a directive.

Accordingly, there currently is no type of mechanism that can compile the contextual factors of a user's application request to determine whether it is appropriate, and leverage such decision to control how applications executing on a device, as well as the device and/or network themselves, are configured, operate and/or are capable of being accessed.

To that end, according to some embodiments, disclosed are systems and methods that provide a novel framework for personalized application control management for a user. As discussed herein, the disclosed framework can operate by providing dynamically determined, customized application management mechanisms that provide non-native functionality to applications, networks and/or devices executing thereon to enable, thwart and/or manipulate how applications can be accessed, which features are accessible and/or whether such applications and/or features are accessible via connected network functionality. Thus, the disclosed systems and methods provide a comprehensive application optimization framework that imparts an electronic robust management and control tool that can provide functional operations as to how devices and/or networks respond to application access requests, which can be dependent on learned activities corresponding to specific times and/or locations.

According to some embodiments, as discussed in more detail below, the disclosed framework can control and/or manage, but is not limited to, read/write access to applications and/or features of such applications, read/write features to network access points and/or hosted/accessible resources, read/write access to device configurations and/or capabilities that enable particular application features, and the like, or some combination thereof. Thus, while the discussion herein may focus on determining how to respond to an application request, it should not be construed as limiting, as the disclosed framework can enable, but is not limited to, network management (e.g., throttling), time-based access, geo-fenced access, and/or other types of permissions and controls that can impact how an application can function. For example, if an application is deemed appropriate, but only for a short-time, the application may be permitted “read” access for 30 minutes while only within a triangulated area around the user's home.

According to some embodiments, as discussed herein, the disclosed framework can collect data about a user's usage of an application, which can be from any device associated with a user as well as from a variety of data resources (e.g., cloud-hosted data, for example), as discussed in more detail below in relation to at least FIGS. 1 and 3-4. For example, data collected from a user's smart phone, sensors at a location and/or network-based data stored in a cloud can provide the data from which the disclosed framework can learn and/or determine/develop a personalized application pattern(s), which can be utilized to manage (e.g., real-world and/or digital) factors for how, where and/or when applications' can be utilized, accessed and/or launched.

According to some embodiments, a method is disclosed for a DI-based computerized framework for automatically and dynamically managing real-time application usage on connected devices. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for automatically and dynamically managing real-time application usage on connected devices.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates an exemplary workflow according to some embodiments of the present disclosure;

FIG. 5 depicts an exemplary implementation of an architecture according to some embodiments of the present disclosure;

FIG. 6 depicts an exemplary implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

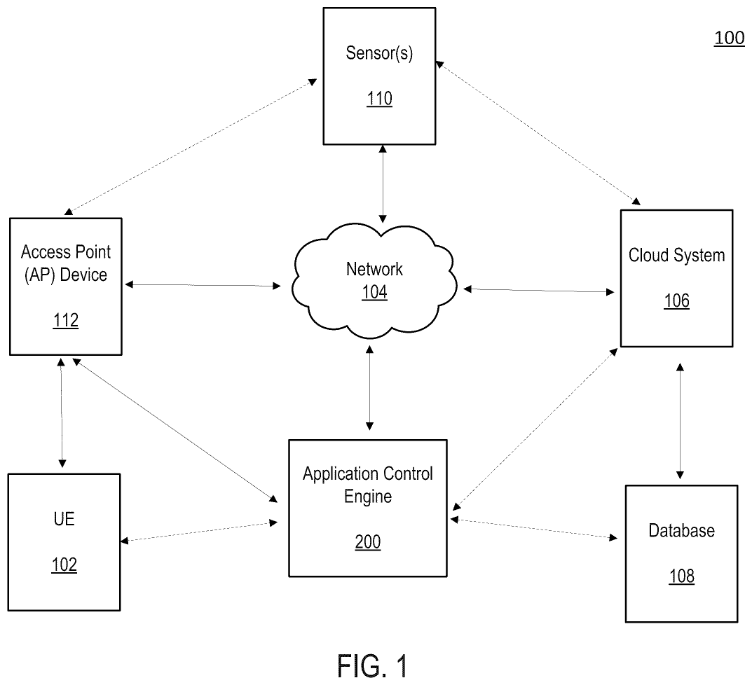

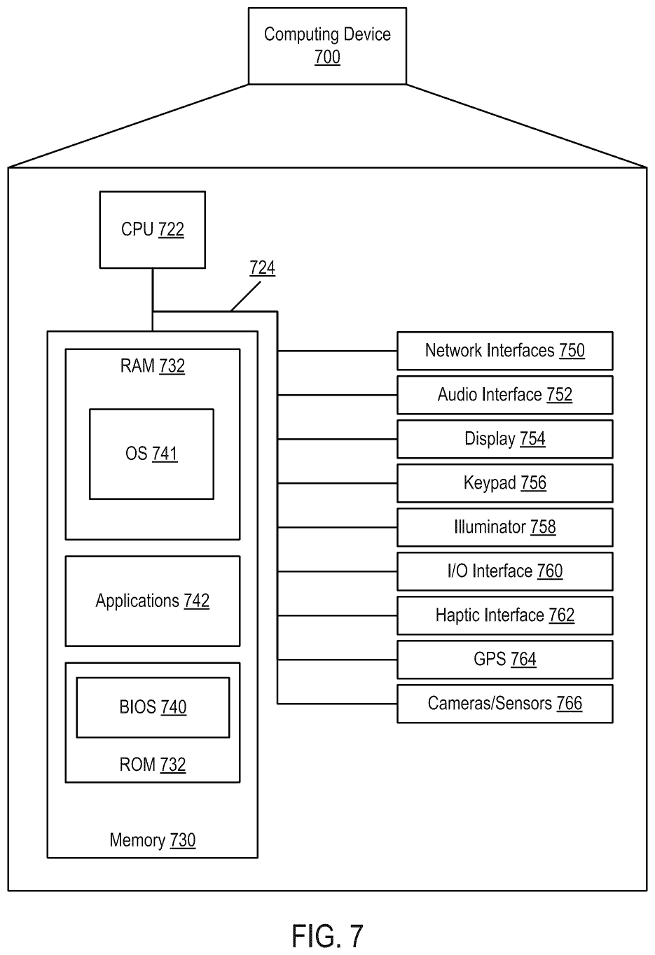

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 7), access point (AP) device 112, network 104, cloud system 106, database 108, sensors 110 and application control engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, IoT device, autonomous machine, and any other device equipped with a cellular or wireless or wired transceiver. For example, UE 102 can be a smart phone with applications installed and/or accessible thereon.

In some embodiments, a peripheral device (not shown) can be connected to UE 102, and can be any type of peripheral device, such as, but not limited to, a wearable device (e.g., smart ring or smart watch), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like. For example, the peripheral device can be a smart phone, smart ring, smart watch or other wearable device that connectively pairs with UE 102, which is a user's laptop.

According to some embodiments, AP device 112 is a device that creates a wireless local area network (WLAN) for the location. According to some embodiments, the AP device 112 can be, but is not limited to, a router, switch, hub and/or any other type of network hardware that can project a WiFi signal to a designated area. For example, an AP device 112 can be a Plume Pod™, and the like. In some embodiments, UE 102 may be an AP device.

According to some embodiments, sensors 110 (or sensor devices 110) can correspond to any type of device, component and/or sensor associated with a location of system 100 (referred to, collectively, as “sensors”). In some embodiments, the sensors 110 can be any type of device that is capable of sensing and capturing data/metadata related to a user and/or activity of the location. For example, the sensors 110 can include, but not be limited to, cameras, motion detectors, door and window contacts, heat and smoke detectors, passive infrared (PIR) sensors, time-of-flight (ToF) sensors, and the like.

In some embodiments, the sensors 110 can be associated with devices associated with the location of system 100, such as, for example, lights, smart locks, garage doors, smart appliances (e.g., thermostat, refrigerator, television, personal assistants (e.g., Alexa®, Nest®, for example)), smart rings, smart phones, smart watches or other wearables, tablets, personal computers, and the like, and some combination thereof. For example, the sensors 110 can include the sensors on UE 102 (e.g., smart phone) and/or peripheral device (e.g., a paired smart watch). In another example, sensors 110 can correspond to the sensors on a user's smart ring.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider, which has associated network resources hosted on the internet or private network (e.g., network 104), which enables (via engine 200) the sleep management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, sensors 110, and the services and applications provided by cloud system 106 and/or application control engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

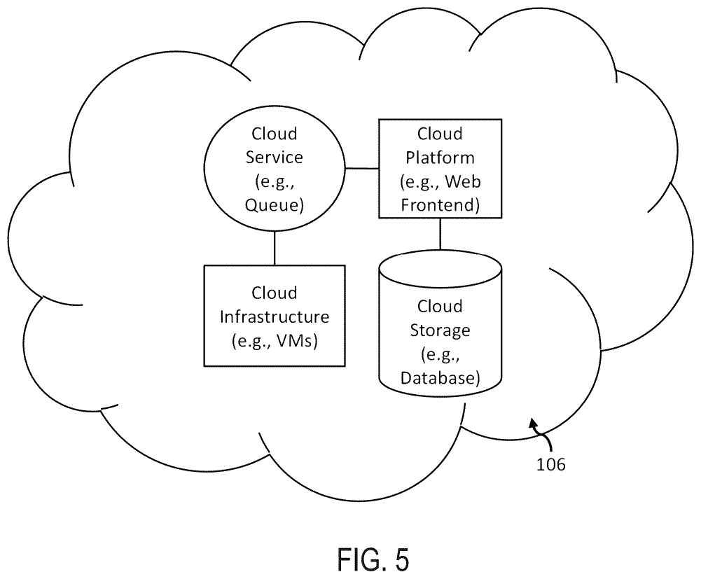

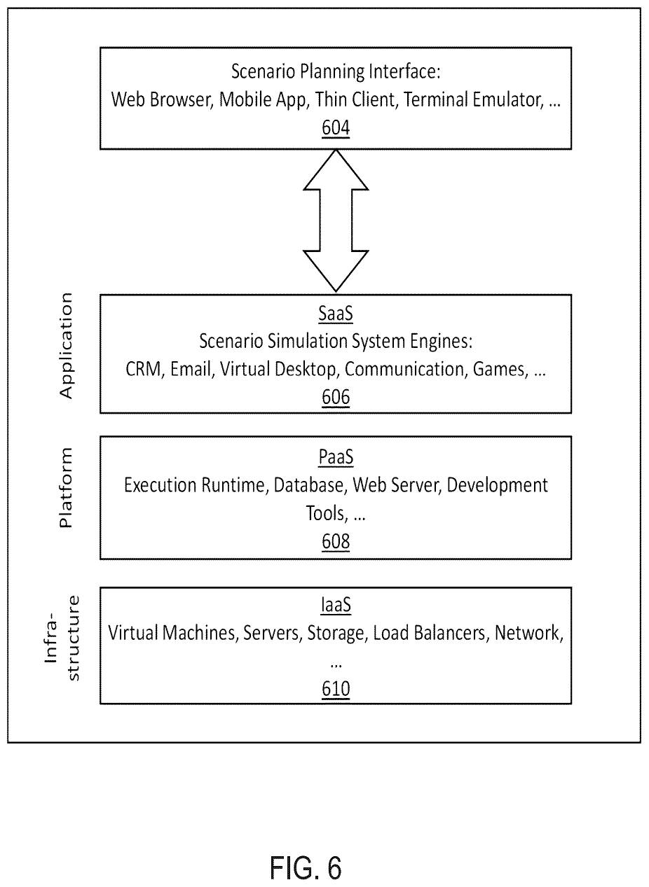

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 120 such as, but not limiting to: infrastructure as a service (IaaS) 610, platform as a service (PaaS) 608, and/or software as a service (SaaS) 606 using a web browser, mobile app, thin client, terminal emulator or other endpoint 604. FIGS. 5 and 6 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository

Application control engine 200, as discussed above and further below in more detail, can include components for the disclosed functionality. According to some embodiments, application control engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

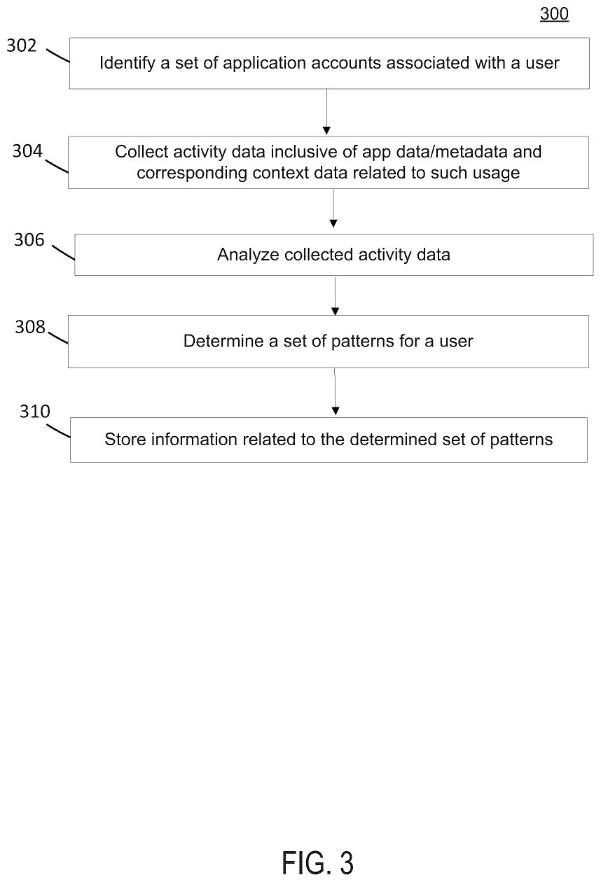

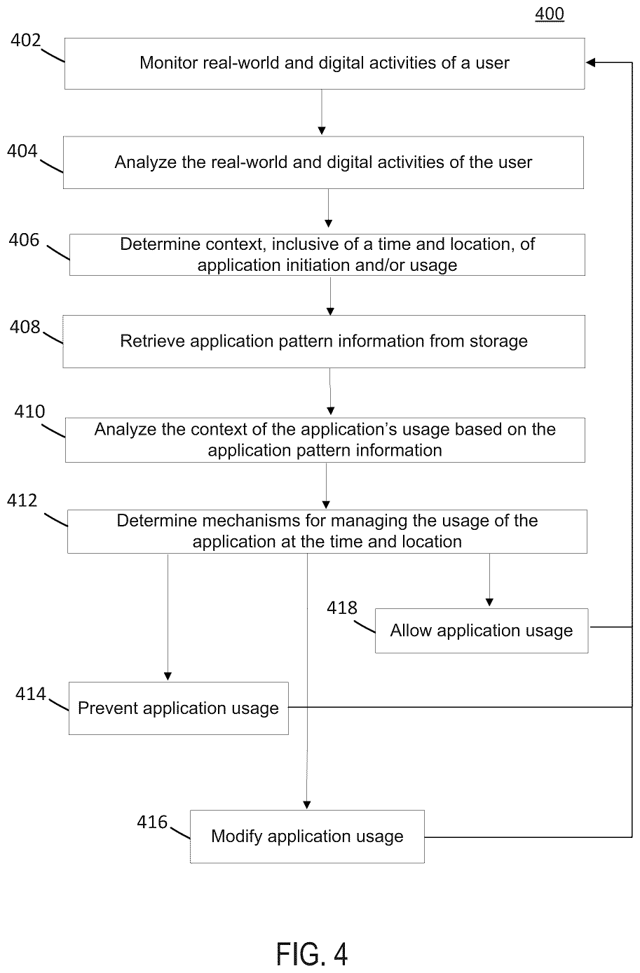

According to some embodiments, as discussed in more detail below, application control engine 200 may be configured to implement and/or control a plurality of services and/or microservices, where each of the plurality of services/microservices are configured to execute a plurality of workflows associated with performing the disclosed security management. Non-limiting embodiments of such workflows are provided below in relation to at least FIGS. 3-4.

According to some embodiments, as discussed above, application control engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102 (and/or AP device 112, in some embodiments). In some embodiments, such application may be a web-based application accessed by AP device 112, UE 102 and/or other devices over network 104 from cloud system 106. In some embodiments, engine 200 may be configured and/or installed as an augmenting script, program or application (e.g., a plug-in or extension) to another application or program provided by cloud system 106 and/or executing on AP device 112 and/or UE 102.

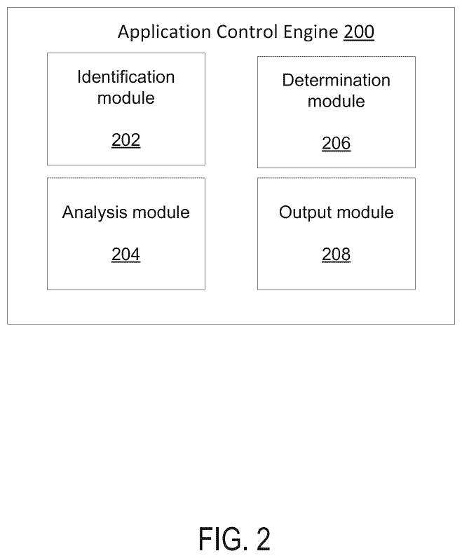

As illustrated in FIG. 2, according to some embodiments, application control engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed application management framework. According to some embodiments, Process 300 provides non-limiting embodiments for determining contextual user information related to how applications are used and/or interacted with, and leverage such information to determine corresponding patterns of behavior for which the disclosed framework (e.g., via application control engine 200) can control, manage and manipulate the operational status such applications based therefrom. As discussed below at least in relation to Process 400 of FIG. 4, the leveraged and stored information can be utilized to optimize, control, manage, allow and/or prevent such application usage/interactions.

It should be understood that while the discussion herein will be with reference to an application(s) executing on a device, it should not be construed as limiting, as any type of program, website, network resource, platform or device (e.g., any of the UEs discussed above) can form the basis of determining patterns of activity, as discussed herein, without departing from the scope of the instant disclosure.

According to some embodiments, Steps 302-304 of Process 300 can be performed by identification module 202 of application control engine 200; Step 306 can be performed by analysis module 204; Step 308 can be performed by determination module 204; and Step 310 can be performed by output module 208.

According to some embodiments, Process 300 begins with Step 302 where a set of application accounts associated with a user are identified. Application accounts can correspond to accounts of a user(s) that enable the usage of an application(s) and/or application program interface (API). According to some embodiments, the application accounts can include information related to, but not limited to, user identifier (ID), username/password or other login credentials (e.g., biometrics), user demographics, location, device ID, application ID, SSID for a connected network, and the like, or some combination thereof.

As discussed herein, reference to an application can include any type of known or to be known computer-executable program or software-backed API that can be access, hosted, stored and/or executed by UE 102 (e.g., apps installed on UE 102 and/or accessed by UE 102 via network 104)—for example, social media applications, messaging applications (e.g., email, SMS, MMS), health applications, news applications, calendar applications, and the like.

Accordingly, Step 302 can involve engine 200 identifying information related to an application or set of applications associated with a device and/or set of devices associated with a user, whereby such information can correspond to, but not be limited to, a time of usage, location of usage (e.g., which network resources are accessed and/or what the corresponding device's GPS coordinates during such usage, for example), type and/or activity involved in such usage, type and/or ID of application, type and/or ID of device, ID of a network (e.g., which WiFi network is connected to, for example) and the like, or some combination thereof.

In Step 304, engine 200 can operate to trigger the identified devices to collect data about the application (e.g., referred to as activity data). According to some embodiments, the activity data can be collected continuously and/or according to a predetermined period of time or interval. In some embodiments, activity data may be collected based on detected events. In some embodiments, type and/or quantity of user data may be directly tied to the type of application and/or device performing such activity data collection. For example, a motion sensor at location can provide a context as to where the user is within the location when such activity data is initiated and/or peaking during such application usage. In another non-limiting example, a gyroscope sensor on a user's smartphone can detect when a user is moving position and/or typing (e.g., via keyboard, for example), the type and/or metrics of such movements.

In some embodiments, such activity data may be derived and/or mined from stored activity data within an associated datastore or cloud. For example, engine 200 can be associated with a cloud, which can store collected network traffic and/or collected activity data for the user in an associated account of the user. Thus, in some embodiments, Step 304 can involve querying the cloud for information about the user, which can be based on a criteria that can include, but is not limited to, a time, date, location, activity, event, application ID/type, other collected user data, and the like, or some combination thereof.

In some embodiments, the collected activity data in Step 304 can be stored in database 108 in association with ID of a user, ID of the application, ID of the device, ID of the location and/or an ID of an account of the user/location, and the like.

In Step 306, engine 200 can analyze the collected activity data. According to some embodiments, engine 200 can implement any type of known or to be known computational analysis technique, algorithm, mechanism or technology to analyze the collected activity data from Step 306.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naïve Bayes, bagging, random forests, logistic regression, and the like. By way of a non-limiting example, engine 200 can implement an XGBoost algorithm for regression and/or classification to analyze the user data, as discussed herein.

According to some embodiments, the AI/ML computational analysis algorithms implemented can be applied and/or executed in a time-based manner, in that collected user data for specific time periods can be allocated to such time periods so as to determine patterns of activity (or non-activity) according to a criteria. For example, engine 200 can execute a Bayesian determination for a predetermined time span, at preset intervals (e.g., a 24 hour time span, every 8 hours, for example) and/or at certain locations (e.g., at work, the store, home, in the car, and the like), so as to segment the day according to applicable time- and/or location-based patterns, which can be leveraged to determine, derive, extract or otherwise activities/non-activities in/around a location(s).

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 308, based on the analysis from Step 306, engine 200 can determine a set of patterns for a user(s) (and/or patterns for the application(s)). According to some embodiments, the determined patterns are based on the computational AI/ML analysis performed via engine 200, as discussed above.

In some embodiments, the set of patterns can correspond to, but are not limited to, types of events, types of detected activity, a time of day, a date, location, type of user, duration, amount of activity, quantity of activities, sublocations within the location (e.g., rooms in the house, for example), type and/or identify of connected network (e.g., cellular versus WiFi, for example), and the like, or some combination thereof. Accordingly, the patterns can be specific to, but not limited to, a user, an application, a device, a network, and/or specific to the location (e.g., or room within a location—for example, the bedroom of the location), and the like, or some combination thereof.

Thus, according to some embodiments, Step 308 can involve engine 200 determining a set of activity patterns for the user's usage of an application(s) based on the activity data, which as discussed below at least in relation to Process 400 of FIG. 4, can be utilized to generate and/or execute mechanisms for controlling how, when and/or where such applications can be used by the user.

In Step 310, engine 200 can store the determined set of patterns in database 108, in a similar manner as discussed above. According to some embodiments, Step 310 can involve creating a data structure associated with each determined pattern, whereby each data structure can be stored in a proper storage location associated with an ID of the user/application/device/location, as discussed above.

In some embodiments, a pattern can comprise a set of events, which can correspond to an activity and/or non-activity (e.g., sending messages, watching media, typing, scrolling, downloading, uploading, and the like, for example). In some embodiments, the pattern's data structure can be configured with header (or metadata) that identifies a user, application, device and/or the location, and a location and/or a time period/interval of analysis (as discussed above); and the remaining portion of the structure providing the data of the activity/non-activity and status of such activities during such sequence(s). In some embodiments, the data structure for a pattern can be relational, in that the events of a pattern can be sequentially ordered, and/or weighted so that the order corresponds to events with more or less activity.

In some embodiments, the structure of the data structure for a pattern can enable a more computationally efficient (e.g., faster) search of the pattern to determine if later detected events correspond to the events of the pattern, as discussed below in relation to at least Process 400 of FIG. 4. In some embodiments, the data structures of patterns can be, but are not limited to, files, arrays, lists, binary, heaps, hashes, tables, trees, and the like, and/or any other type of known or to be known tangible, storable digital asset, item and/or object.

According to some embodiments, the activity data can be identified and analyzed in a raw format, whereby upon a determination of the pattern, the data can be compiled into refined data (e.g., a format capable of being stored in and read from database 108). Thus, in some embodiments, Step 310 can involve the creation and/or modification (e.g., transformation) of the activity data into a storable format.

In some embodiments, as discussed below, each pattern (and corresponding data structure) can be modified based on further detected behavior, as discussed below in relation to Process 400 of FIG. 4.

Turning to FIG. 4, Process 400 provides non-limiting example embodiments for the deployment and/or implementation of the disclosed application control framework.

According to some embodiments, Steps 402 and 408 can be performed by identification module 202 of application control engine 200; Steps 404 and 410 can be performed by analysis module 204; Steps 406 and 412 can be performed by determination module 206; and Steps 414-418 can be performed by output module 208.

According to some embodiments, Process 400 begins with Step 402 where engine 200 can monitor a device(s) of a user to detect, determine or otherwise identify real-world and/or digital activities of the user. In some embodiments, such activities can correspond to, but are not limited to, user movement, physical location of the user/device, network resource access and download requests, website visits, application initiations and/or engagements, device usage, network connectivity, and the like, or some combination thereof.

According to some embodiments, Step 402 can be triggered upon a user connected to a network, for example, a WiFi network, whereby the network's service set identifier (SSID) can be broadcast and identified and utilized via the user's device (e.g., UE 102, for example—a smart phone).

In some embodiments, engine 200 can monitor the device and/or activity related to the user/device continuously, according to a predetermined time interval and/or upon detection of an event (e.g., SSID identification/connection, application launch request, arrival at a specific location, and the like). For example, upon a user being determined to have arrived at work (e.g., via the user's device connecting to the work WiFi network), Step 402 can be triggered.

In Step 404, based on the monitoring of the location, engine 200 can analyze the monitored real-world and/or digital activities (and corresponding collected data based therefrom), which can be performed in a similar manner as discussed above at least in relation to Step 306.

In Step 406, engine 200 can determine a context of an application initiation and/or usage. For example, in Step 402, engine 200 detects that the user is requesting access to an application (e.g., provides a touch input on their smart phone indicating a desire to open an application). In Step 402, engine 200 can further identify/determine information related to the request, which can include, but is not limited to, time, date, location, user ID, device ID, device type, application type, application ID, and the like, or some combination thereof. And, in Step 404, such information can be analyzed, whereby in Step 406, engine 200 can determine a context of the application's usage.

According to some embodiments, the context can include information related to, but not limited to, an intent of the user for the application (e.g., if it's a social application, then social intentions; if a CAD program, then since the user is an architect, this would be for business purposes, for example), a time, location, and the like. Thus, in some embodiments, the context can provide temporal and/or spatial data related to the usage, which correlate to an intention as defined by where the user is at certain times/dates.

In Step 408, engine 200 can retrieve application pattern information from storage (as per Step 310, discuss supra). In some embodiments, such retrieval can be based on, but not limited to, a time, date, user ID, application ID, context, device ID, network ID, and the like, or some combination thereof. For example, if the context (from Step 406) corresponds to a user at work on a Monday, then a pattern for the user's application usage patterns on Monday at work can be retrieved.

In Step 410, engine 200 can analyze the context of the application's usage based on the application pattern information. Such computational analysis can be performed in a similar manner as discussed above respective the AI/ML model applications in Steps 404 and Step 306.

In Step 412, engine 200 can, based on the analysis from Step 410, determine which mechanisms can be defined, implemented and/or provided for the management and control of the usage of the application at the time and location of the application's requests. According to some embodiments, the mechanisms can be configured as executable files and/or data structures that enable the operations of specifically configured capabilities and/or functionalities (e.g., via engine 200) to control, manipulate and/or manage how an application can function on a network.

In some embodiments, such mechanisms can involve management of, but not limited to, a network (e.g., throttle and/or increase bandwidth for the device/application), the device (e.g., increase or decrease memory usage for the application), the application (e.g., prevent or modify available features on the application (e.g., can download content but cannot upload, for example; which can be dependent upon the capabilities of each specific application), and the like, or some combination thereof.

Accordingly, in some embodiments, based on the determination in Step 412, engine 200 can perform at least one of Steps 414, 416 and 418.

In Step 414, the application usage (e.g., launch and/or usage) of the application can be prevented, or halted if already in progress prior to Step 402, 404 and/or 406. In some embodiments, Step 414 can involve causing the application to be secured via a token which can prevent its access from executable and/or registry files in a corresponding device. For example, the application can be automatically quarantined via an access point of the network for a predetermined period of time. For example, if a user is determined to be at work, then playing gaming applications can be prevented.

In Step 416, engine 200 can implement a mechanism(s) that can modify how the application can be executed (e.g., how the application can be used). Such modification can include, but not be limited to, restraint of particular types and/or quantities of features, time-limits, geographic limits, user limits (e.g., controls for particular accounts), and the like or some combination thereof. For example, if the application is a social media application, then the user may be prevented from posting certain links, and viewing the app more than n minutes (e.g., 30 minutes) before it shuts down.

And, in Step 418, engine 200 can execute a mechanism whereby read/write controls are provided to the user and/or corresponding device to launch, use and/or access the device in a manner consistent with the application's request. For example, the user can be enabled to view and use the application in a typical normal fashion. For example, if the user is at work and typically uses their email application; then, in Step 418, engine 200 can enable typical email usage via that application. However, as indicated via the recursive line back to Step 402, the activities on the application can be monitored such that should email activity surpass normal usage, mechanisms can be implemented to prevent further usage (e.g., via Step 414) and/or modify its usage (e.g., via Step 416).

Accordingly, after Steps 414, 416 and/or Step 418, engine 200 may then continue monitoring the application, device, network and/or. In some embodiments, the monitoring can continue running in the backend, while certain modules of engine 200 execute to maintain the application management framework for ongoing and/or to-be received application requests.

According to some embodiments, a user, application, device and/or location can have a dedicated engine 200 model so that the application control protocols discussed herein can be specific to the events and patterns learned and detected for the user, application, device and/or at that location. In some embodiments, the model can be specific for a user or set of users (e.g., users that live at a certain location (e.g., a house).

FIG. 7 is a schematic diagram illustrating a client device showing an example embodiment of a client device that may be used within the present disclosure. Client device 700 may include many more or less components than those shown in FIG. 7. However, the components shown are sufficient to disclose an illustrative embodiment for implementing the present disclosure. Client device 700 may represent, for example, UE 102 discussed above at least in relation to FIG. 1.

As shown in the figure, in some embodiments, Client device 700 includes a processing unit (CPU) 722 in communication with a mass memory 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device 700 may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by a device, a request to access an application
analyzing, by the device, data related to current real-world and digital activities of a user;
determining, by the device, based on the analysis, a context of the request, the context corresponding to a time and location of application usage;
analyzing, by the device, the context based on a pattern of activity for the user, the pattern of activity comprising information related to learned usage of the application;
determining, by the device, based on the analysis of the context, a mechanism for managing the application in response to the request; and
causing the device to respond to the access request by executing the mechanism, the mechanism automatically providing controls to how the application and application features can operate on a network.

2. The method of claim 1, wherein the mechanism corresponds to at least one of a function preventing usage of the application, modifying application usage and allowing read/write access to the application.

3. The method of claim 1, wherein the mechanism corresponds to at least one of a time and location for which the context is permitted.

4. The method of claim 1, further comprising:
monitoring the real-world and digital activities by tracking device data for a time period;
analyzing the device data; and
determining the context of the request further based on the analysis of the device data.

5. The method of claim 4, wherein the tracking of the device data is based on at least one of a device identifier (ID) and service set identifier (SSID) for the network.

6. The method of claim 1, wherein the mechanism corresponds to at least one of a modification of how the network is accessible by the device or application and a modification of how the device functions in response to application instructions.

7. The method of claim 1, wherein the context provides an indication of an intent of the user at the time and location for use of the application.

8. The method of claim 1, further comprising:
identifying a set of applications associated with the user;
collecting data from each of the set of applications;
analyzing, via an application, the collected data;
determining, via the application, a set of patterns of activity for the user; and
storing, in a database, the set of patterns of activity, wherein the pattern of activity is identified from the stored determined pattern of activity.

9. The method of claim 8, wherein the set of applications corresponds to applications executing on the device of the user for which the user has account information associated therewith.

10. The method of claim 1, wherein the device is a user device.

11. A device comprising:
a processor configured to:
receive a request to access an application
analyze data related to current real-world and digital activities of a user;
determine, based on the analysis, a context of the request, the context corresponding to a time and location of application usage;
analyze the context based on a pattern of activity for the user, the pattern of activity comprising information related to learned usage of the application;
determine, based on the analysis of the context, a mechanism for managing the application in response to the request; and
cause the device to respond to the access request by executing the mechanism, the mechanism automatically providing controls to how the application and application features can operate on a network.

12. The device of claim 11, wherein the mechanism corresponds to at least one of a function preventing usage of the application, modifying application usage and allowing read/write access to the application.

13. The device of claim 11, wherein the processor is further configured to:
monitor the real-world and digital activities by tracking device data for a time period, wherein the tracking of the device data is based on at least one of a device identifier (ID) and service set identifier (SSID) for the network;
analyze the device data; and
determine the context of the request further based on the analysis of the device data.

14. The device of claim 11, wherein the mechanism corresponds to at least one of a modification of how the network is accessible by the device or application and a modification of how the device functions in response to application instructions.

15. The device of claim 11, wherein the context provides an indication of an intent of the user at the time and location for use of the application.

16. A non-transitory computer-readable storage medium tangibly encoded with computer-executable instructions that when executed by a device, perform a method comprising:
receiving, by a device, a request to access an application
analyzing, by the device, data related to current real-world and digital activities of a user;
determining, by the device, based on the analysis, a context of the request, the context corresponding to a time and location of application usage;
analyzing, by the device, the context based on a pattern of activity for the user, the pattern of activity comprising information related to learned usage of the application;
determining, by the device, based on the analysis of the context, a mechanism for managing the application in response to the request; and
causing the device to respond to the access request by executing the mechanism, the mechanism automatically providing controls to how the application and application features can operate on a network.

17. The non-transitory computer-readable storage medium of claim 16, wherein the mechanism corresponds to at least one of a function preventing usage of the application, modifying application usage and allowing read/write access to the application.

18. The non-transitory computer-readable storage medium of claim 16, further comprising:
monitoring the real-world and digital activities by tracking device data for a time period, wherein the tracking of the device data is based on at least one of a device identifier (ID) and service set identifier (SSID) for the network;
analyzing the device data; and
determining the context of the request further based on the analysis of the device data.

19. The non-transitory computer-readable storage medium of claim 16, wherein the mechanism corresponds to at least one of a modification of how the network is accessible by the device or application and a modification of how the device functions in response to application instructions.

20. The non-transitory computer-readable storage medium of claim 16, wherein the context provides an indication of an intent of the user at the time and location for use of the application.
